(19) United States
(12) Patent Application Publication
(10) Pub. No.: US 2015/0323117 A1
(43) Pub. Date: Nov. 12, 2015

(54) PLUG ELEMENT WITH AT LEAST ONE BODY PART MADE FROM SHAPE-MEMORY-ALLOY

(71) Applicant: Norbert Martin, Celle (DE)

(72) Inventor: Norbert Martin, Celle (DE)

(21) Appl. No.: 14/707,327

(22) Filed: May 8, 2015

(30) Foreign Application Priority Data
May 8, 2014 (DE) 10 2014 006 616.9

(51) Int. Cl. F16L 55/132

(52) U.S. Cl. CPC F16L 55/132

(57) ABSTRACT

Plug element with at least one body part (21, 31, 32, 33) comprising a shape-memory-alloy material (14) and connectable with at least one carrier element (2, 3) in such a way that the body part (21, 31, 32, 33) is at least radially in contact to the carrier element in certain areas. The body part is coolable and can be mechanically deformed to a first shape that it can be transformed into a second shape by the subsequent heating, in which the body part (21, 31, 32, 33) is radially in contact to the carrier element (2, 3).

The present invention concerns a plug element with at least one body part which comprises a material from shape-memory-alloy which is connectable to at least one carrier element in such a way that the body part is at least radially in contact to the carrier element in certain areas.

Furthermore, the invention concerns a repair kit for the preparation of plug elements and a procedure for the preparation of a plug element with a body based on a shape-memory-alloy.

From DE60 2004 000 994 T2 a shape-memory-alloy develops comprising Co, Ni. and Al. The shape-memory-alloy features a two-phase-structure comprising a β-phase with B2-structure and a γ-phase with fc-structure. At least 40 percent of the area of the crystal grain boundary of the β-phase are taken by the γ-phase. The alloy contains 23 to 27 atomic percent Al, 39 to 45 atomic percent Co, 28 to 38 atomic percent Ni as unavoidable impurities.

Shape-memory-alloys known from the state of the art prove to be disadvantageous as these alloys require to be kept in liquid nitrogen to maintain the shape stability during production, storage and assembly. Such a production proves to be procedurally elaborate and expensive.

Moreover, the handling of liquid nitrogen poses an increased health hazard. Liquid nitrogen is nitrogen in its liquid physical condition which boils at 77K under normal pressure.

The expansion rate of nitrogen from the liquid to the gaseous state amounts to 1:694. As a result the boiling of liquid nitrogen poses an increased danger of explosion.

Due to the low temperature the liquid nitrogen may immediately cause frostbite at hands and body when being processed.

Especially when the liquid nitrogen evaporates it reduces the concentration of oxygen in the air what may cause an oxygen deficit especially in confined spaces.

This is extremely dangerous since nitrogen is odorless, colorless and tasteless with the result that dyspnea may eventuate without prior warning.

In addition to that liquid nitrogen causes a severe oxidation to organic materials.

Therefore, the invention sets the task to create a plug element based on a material from a shape-memory-alloy which may still be processed, handled, stored and assembled beyond an environment of liquid nitrogen.

In addition to that a plug element is provided implementing a function both as a seal and carriage. Moreover, the plug element implements other functions, e.g. as engagement or connection.

In standardized size the plug element according to the invention especially seals pipe profile ends of different diameters.

According to the invention the plug element tightly connects pipe profiles of the same and/or different diameters without using additional sealants.

The shape-memory-alloy of the plug element features an austenitic resp. martensitic phase allowing for an application resp. use of the plug element especially in compliance with specific safety regulations in air traffic.

In addition to that a plug element is created featuring an improved elasticity and an optimized sealing property.

The function according to the invention is implemented by a plug element with at least one body part which comprises a material from shape-memory-alloy which is connectable to at least one carrier element in such a way that the body part is at least radially in contact to the carrier element in certain areas. The body part is coolable and in a first forming mechanically deformed that it may be transformed into a second shape by subsequent heating in which the body part is radially solid and in tight contact to the carrier element.

Furthermore, the function is implemented by a repair kit including at least two plug elements whose body parts feature different lengths.

Additionally, the function is implemented by a procedure for the preparation of a plug element embracing a body based on a shape-memory-alloy.

Subsequently, the invention is described exemplarily and in no way limiting using the example of a plug element embracing at least one turn of wire made from a shape-memory-alloy.

According to the invention the wire made from a shape-memory-alloy undergoes a cold forming to adjust the wire to the desired length and the desired diameter.

The required widening of the inner diameter of the plug element by cold forming may be achieved by semi-finished production. The invention defines the term cold forming as the reshaping of metals at a temperature significantly below the temperature of recrystallization.

The wire made from shape-memory-alloy may preferably be pulled through a cavity bringing it to the desired diameter. This way the outer diameter of the plug element may be minimized after welding of the turns of wire while maintaining the flexibility of the shape-memory-alloy.

Due to a wall thickness of preferably 1 to 4 or 5 mm the outer diameter of the plug element may be adjusted to the specific requirements respectively the predominating space conditions. The body part of the plug element features at least two or more turns of wire made from a shape-memory-alloy. The turns of wire may vary in width and wall thickness.

At least one body part of the plug element embraces at least one turn of a wire made from a shape-memory-alloy. Width and radial thickness of the wire may vary. The width of the wire should preferably be between 1 mm and 5 mm. The thickness of the turn of wire may preferably be 3 mm. The body part of the plug element has at least one turn of wire.

The turns of wire may show different structural shapes. Exemplarily and in no way exclusively the coils may be wired helically or spirally. Yet, any other suitable form of turns may be at hand.

At the same time and at martensitic temperatures of preferably −70° C. an inner widening of preferably 15° may be done.

According to the invention the plug element may be produced downward up to an outer diameter of preferably 8 mm.

The outer diameter of the plug element may preferably be 40 mm with a preferable wall thickness of 4 mm. The storage and processing of the plug element made from a shape-memory-alloy is possible within a stable range between preferably 60° C. and −70° C. without the plug element reverting to its original shape.

The wire may preferably be coiled spirally so that a body part of at least one turn of wire is provided. The turn may be run roundly, ovally, elliptically or polygonally.

After obtaining the desired number of turns of wire, the wire is cut to length and pressed to form a compression spring. Exemplarily and in no way limiting a body part of the plug element showing ten turns from a material made from shape-memory-alloy is assumed afterwards.

The cutting to length of the plug element made from shape-memory-alloy may preferably be done by ceramic cutting. The cutting to length may also be done by water jet cutting or laser cutting. In any case the cutting to length is done while cooling the material at the same time.

For the forming of a cylindrical spring element the turns of spring arranged in parallel are roundly welded together to create a smooth surface especially radially outwardly.

The turns of the wire are preferably connected by laser welding. Yet, other welding procedures or other technical means of connection may be applied to connect the turns of wire.

The welding process takes preferably place by laser welding. Generally, the welding is done without adding a weld metal. The laser radiation is focused by optics. The focal spot has a typical diameter of some tenths mm which may create very high concentrations of energy.

The turns of wire may also be connected to each other by laser keyhole welding or laser-msg-hybrid-welding. The connection of the individual turns of wire is also done by cooling of the turns of wire at the same time.

Moreover, the welding of the turns made from shape-memory-alloy may also be done by any other welding procedure.

Before welding the turns of wire are pressed to block thickness. The body part of the plug element may serve as a reservoir of potential energy. In addition to that the plug element may create a force fit between at least two components.

To normalize mechanical tension which results especially from the cold forming of the wire within the material the plug element created by welding the turns of wire is preferably annealed.

For further refinement and processing of the surface of the plug element remaining edges and/or indentations between the turns of wire welded together are straightened preferably by overtwisting the turns of wire.

Due to the subsequent processing, especially the overtwisting of the plug element the production without fins, edges and other irregularities may be achieved.

It is self-evident that the aforementioned descriptions are only exemplary and in no way exclusive. The turns of wire welded together may certainly be processed, sealed and refined in any necessary way.

The plug element made from shape-memory-alloy is then cooled down to a lower temperature in which the shape-memory-alloy of the wire proceeds to the martensite phase.

It is conceivable that the plug element is widened after cooling and partially shrinks back to its original shape when being heated again.

The plug element in the shape of at least one turn of wire made form shape-memory-alloy may be cooled in such a way that the wire can be mechanically processed regarding its shape and circumference. The winding of the plug element may be expanded resp. widened. It is also possible to shrink the turn of wire of the plug element to a lower diameter.

The turn of wire is brought into a desired geometric shape. In doing so both circumference and shape of the wire and shape and circumference of the turn of wire may be processed. The turns of wire may be widened or shrunk regarding its diameter. By the following heating of the plug element in the martensite phase of the shape-memory-alloy the winding may be transformed into a second shape.

The turns of wire may vary regarding the attenuation factor or attenuation value depending on the area of application and requirements.

Both shapes of the plug element may be preset by the composition of the material made from shape-memory-alloy and/or temperature treatment.

In case of a one-way effect the plug element is apparently plastically formed in its shape-memory-alloy. By the heating of the plug element in the martensite phase the plug element may be transformed into a second shape by exceeding a critical temperature.

In case of a two-way effect the shape-memory-alloy of the plug element shows a first defined shape and a second defined shape.

The transformation of the plug element from the first shape to the second shape takes place by heating or cooling of the shape-memory-alloy.

In case of the two-way effect the respective shapes may only be achieved after falling below resp. after exceeding of a respective limit temperature.

Preferably in the area of aircraft industries the most shape-stable area is between +60° C. and −60° C. Above +60° C. and below −60° C. the shape-memory-alloy of the material of the plug element is instable and may be widened or shrunk.

In case of the one-way effect the plug element is preferably transformed from one shape into another shape in the martensite phase by heating instead of loading.

In the example of a pseudoelasticity the shape-memory-alloy shows the characteristic to perform irreversible deformation of about 8 to 10 percent. In case of pseudoelasticity the kinetic phase transformation takes place by an exterior mechanical tension. With decreasing tension the shape-memory-alloy returns to its austenitic phase. By means of pseudoelasticity a severe transformation is also possible without a change of temperature.

The plug element preferably has a wall thickness between 2 mm and 15 mm. Such a wall thickness allows for a sufficient longitudinal strength and an adequate retention force of the plug element towards the carrier element.

The plug element features at least one body part, preferably two or three body parts. The body parts may be plugged to the carrier elements preferably by using additional sealing elements. The shape-memory-alloy of the plug element allows for a tight force fit of the body part on the carrier element.

The force fit is caused by cooling the body part of the plug element after cold forming of the outer circumference in its first shape. In cooled condition the plug element with its body part is widened or shrunk (second shape). With a new heating the plug element is at least approximately transformed to its first shape again.

According to the invention the plug element may be a shell, a pipe or another hollow profile with adequate geometric shape which can be plugged on one end of the carrier element. A second carrier element is introduced into the body part of the plug element reversely to the first carrier element so that both carrier elements are always adjacent to each other with lash or are separated of each other via a teflon ring on the filling. For the production of the separation ring at least another relatively soft material may be used instead of teflon, preferably a metal.

It is also conceivable that the plug element engages and extends into a second carrier element with the other body part.

The carrier elements which engage into the body parts of the plug element always collide with some lash. Furthermore, it is conceivable that the carrier elements are separated from each other by a teflon ring. For the production of the separation ring at least another relatively soft material may be used instead of teflon, preferably a metal.

In addition to that it is also conceivable that plug element engages into the open end of a carrier element with one body part and is slipped on the open end of another carrier element with a second body part.

According to whether the body part of the plug element is slipped into the open end of the carrier element or on the carrier element a connection of the plug element with the respective body part takes part in which the shape-memory-alloy of the respective body part of the plug element shrinks back or expands to its first shape towards the junction.

The inner diameters of the body part of the plug element are adaptable to carrier elements with different outer diameters due to the shrinking- or expansion-capability of the shape-memory-alloy.

The shrinking or expansion of the plug element to the carrier element causes a seal impermeable to fluids of the plug element towards the respective carrier element.

The body parts of the plug element may show areas with different diameter or may vary regarding its diameter towards the diameter of other body parts.

The plug element may show different spring rates or spring characteristics. Moreover, the plug element may show different levels of efficiency. In this context the term level of efficiency means the extent of efficiency of energy conversion and energy transfer.

According to another embodiment of the invention a once-only change of shape of the turns of wire made from shape-memory-alloy pressed on block may be achieved which has been widened or clinched before in martensitic condition.

A cooling of the plug element with at least one body part made form shape-memory-alloy does not cause another change of shape but an intrinsic change of lattice,

The shape-memory-alloy for the production of at least one body part comprises exemplarily but not exclusively the elements nickel and titanium and/or niobium and/or zirconium. As other materials copper, zinc, aluminum, gold, cadmium and further alloys such as iron, manganese, silicium may be used.

The aforementioned listing is only of exemplary character. Yet, other elements not mentioned may be applied.

For the improvement of the connection between the body part of the plug element and at least one carrier element a structuring at the inner diameter and/or the outer diameter of the body part of the plug element facing the carrier element is envisaged.

The structuring may comprise any type of geometric profiles, preferably a cogging or other patterns.

Another embodiment of the invention includes that the area of the body part of the plug element adjoining the carrier element features diameters deviating from each other. The body parts of the plug element features exemplarily diameters from 4 mm to 30 mm while wall thicknesses from 2 mm to 10 mm are used.

Preferably inner diameters from 4 mm to 30 mm and wall thicknesses from 1 mm to 10 mm are applied.

Assuming that a plug element features at least two body parts made from shape-memory-alloy, preferably three or more body parts made from shape-memory-alloy, the body parts of the plug element may run on a common level. Moreover, it is also conceivable that at least two body parts of a plug element range in an angle to each other, preferably in a right angle to each other.

In this context one or more plug elements are connected to a carrier element with their body parts.

It is also conceivable that plug elements are used to close a body part if this body part is not designed to attach to a carrier element.

According to the invention a repair kit is planned which features at least one plug element with at least one body part made from shape-memory-alloy. The body part of the plug element can be attached to at least one carrier element in such a way that the body part is at least radially in contact to the carrier element in certain areas. The body part preferably features at least one turn of a wire made from shape-memory-alloy. The shape-memory-alloy of the body part is stretchable at changing temperatures while the geometric shape of at least one turn of a wire of a first shape is transformable to another shape. The repair kit may have a carrier element in which the plug element may be inserted for the purpose of transport and/or storage.

For the purpose of protection of the plug element from damages the carrier element may be lined with synthetic material. The synthetic material may be made from e.g. teflon or a PTFE coating. Yet, the aforementioned materials are only exemplary and in no way exclusive. In addition to that single materials or a combination of other materials may be applied.

For application at least one plug element is taken from the carrier element and connected to the carrier element/s.

Depending on how the plug element expands or compresses into the first shape a sealing of the plug element to the inner diameter of the carrier element or to the outer diameter of the carrier element takes place.

The invention at hand also provides a procedure for the production of a plug element which embraces at least one body part based on the shape-memory-alloy.

The storage of the plug element takes place at room temperature.

In the area of aircraft industries the most shape-stable area is the area between plus 50 degree Celsius and minus 60 degree Celsius. Within this range the shape-memory-alloy is instable and may preferably be widened or shrunk.

The required cold forming of the outer diameter of the plug element may be achieved by means of semi-finished production unwrought.

At the same time an inner widening of 15% unwrought may take place at martensitic temperatures of preferably minus 70 degree Celsius.

The plug element according to the invention is also producible downwards to a diameter of preferably 6 mm.

The diameter of the plug element according to the invention at hand may outwards preferably take a value up to 30 mm at a wall thickness of preferably 4 mm.

A storage and processing of the material made from shape-memory-alloy of the plug element is possible within a stable range between preferably plus 50 degree Celsius and mines 70 degree Celsius without the plug element made from material of shape-memory-alloy transforming into its original shape.

According to the invention the body part is fillable with a fluid.

The fluid is a refrigerant or cryogen and is coolable to a predetermined temperature before, during or after the attachment into the body part. The refrigerant in the body part deprives heat from the material of the body part resp. transfers the cold from the refrigerant to the material of the body part. Depending on the requirements the fluid is liquid, gelatinous or gaseous.

The body part can preferably be closed on its fronts for the purpose of filling so the filling in the body part may be applied with pressure. The fluid is applied after the filling of the body part with the fluid or before the filling under pressure.

By the application of the fluid by pressure the fluid widens the interior of the body part. Exemplarily and in no way exclusive the fluid features a pressure of 2,300 bar.

By this the body part deforms to its first shape. During the subsequent heating of the body part the body part is transformable into its second shape in which the body part is at least radially in contact to the carrier element.

Further examples and versions of the invention are subsequently listed only exemplarily and in reference to the attached outlines. Here it shows:

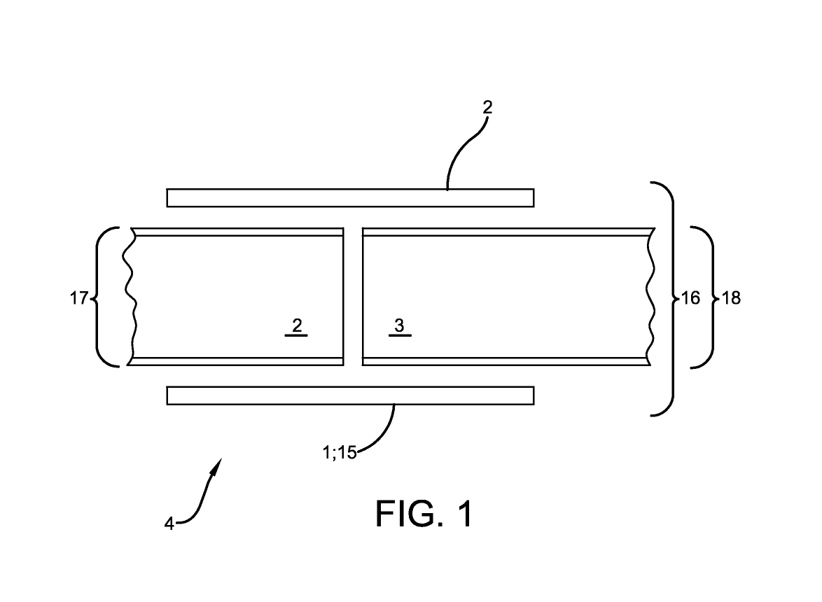

FIG. 1 is a plug element 1 with two carrier elements 2 and 3 where plug element 1 is widened to its first shape,

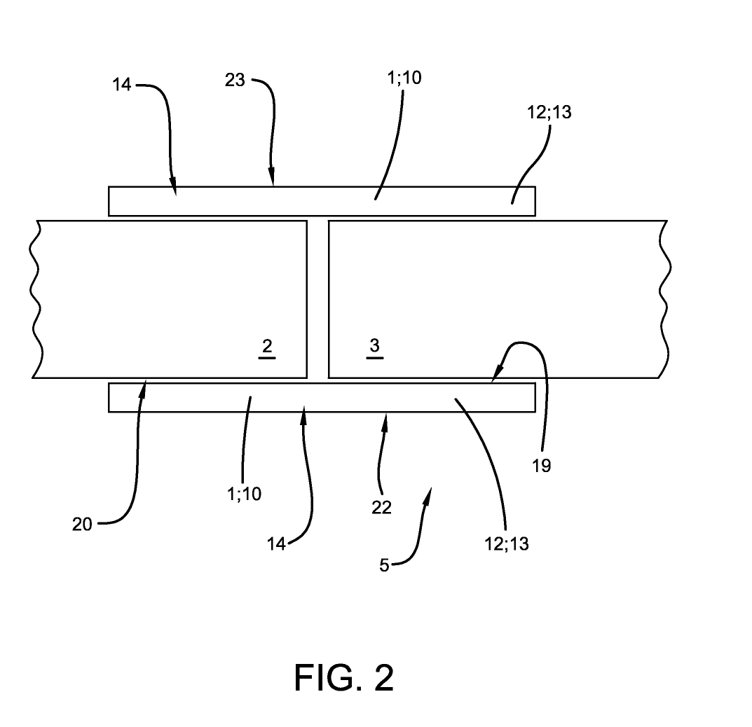

FIG. 2 is a presentation corresponding to FIG. 1 with the difference that the plug element is transformed into its second shape 5 and is in contact to the carrier elements 2, 3,

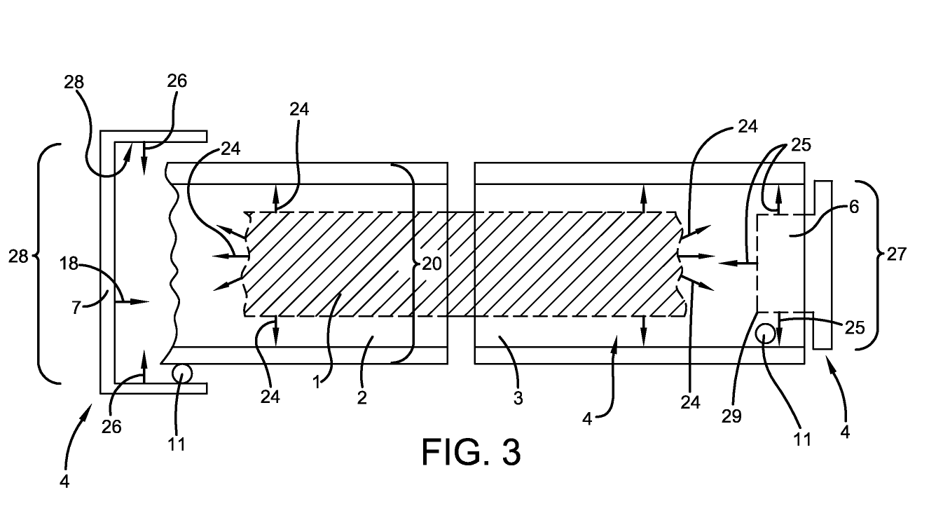

FIG. 3 is a plug element 1 inserted into the carrier elements 2, 3 with an additional plug 6 and 7,

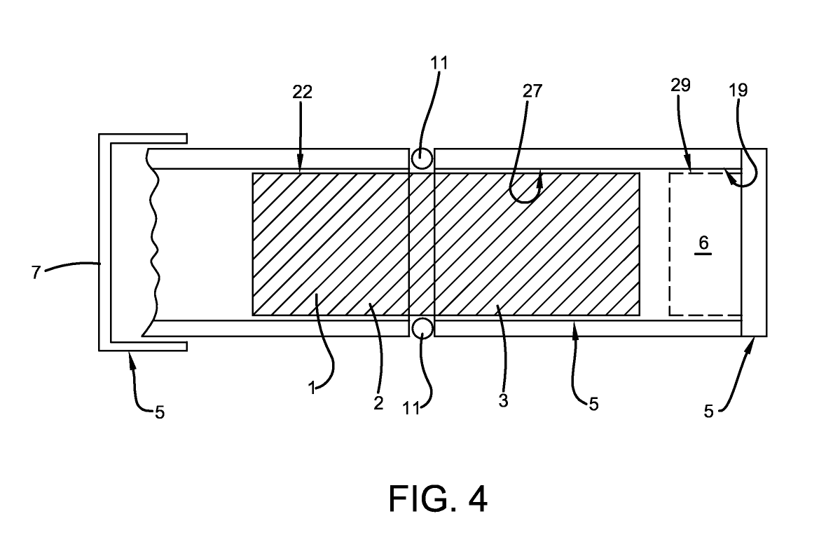

FIG. 4 is a comparable presentation as in FIG. 3 with the difference that the plug element and the plug 6 and 7 are transformed into their second shapes,

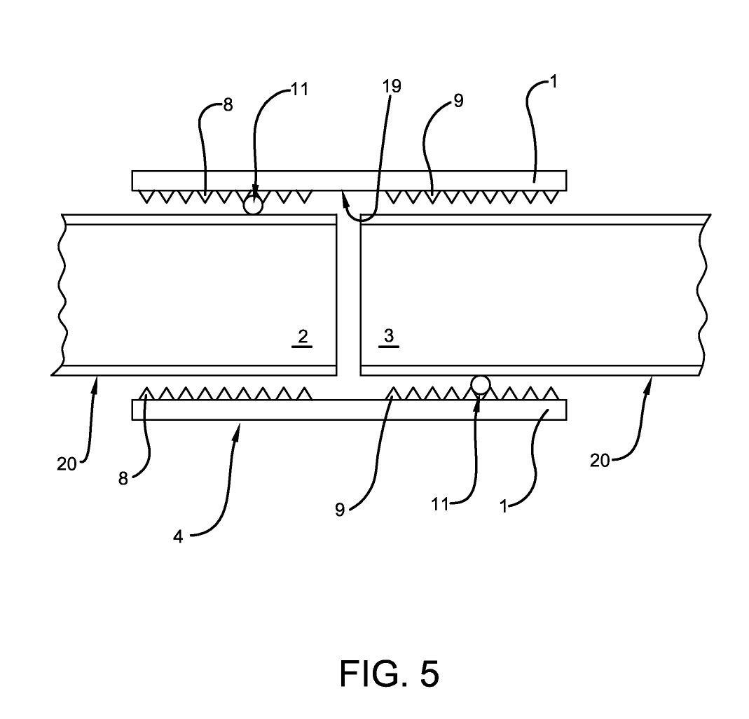

FIG. 5 is a presentation corresponding to FIG. 1 with structure elements 8 and 9,

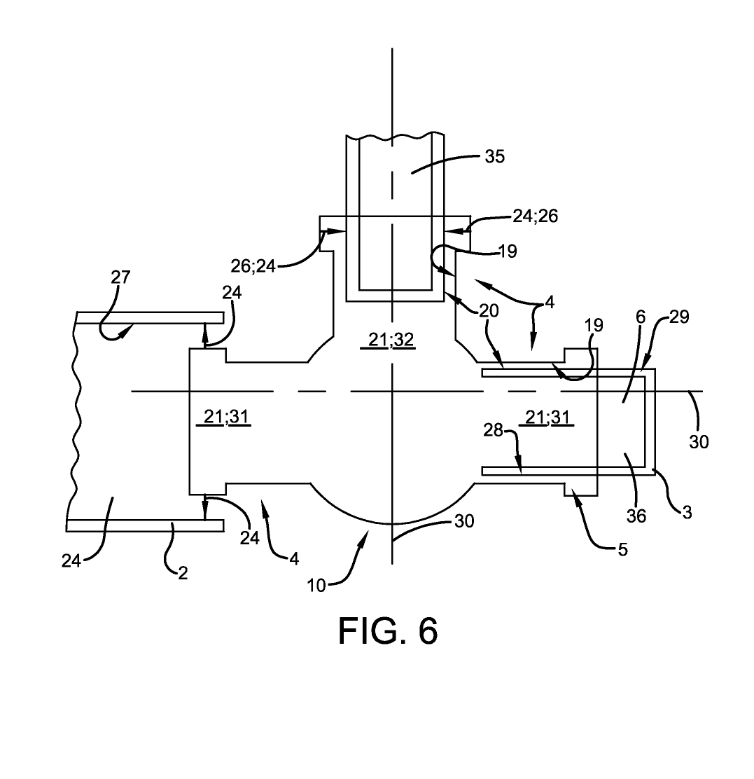

FIG. 6 is a repair kit 10 with three plug elements,

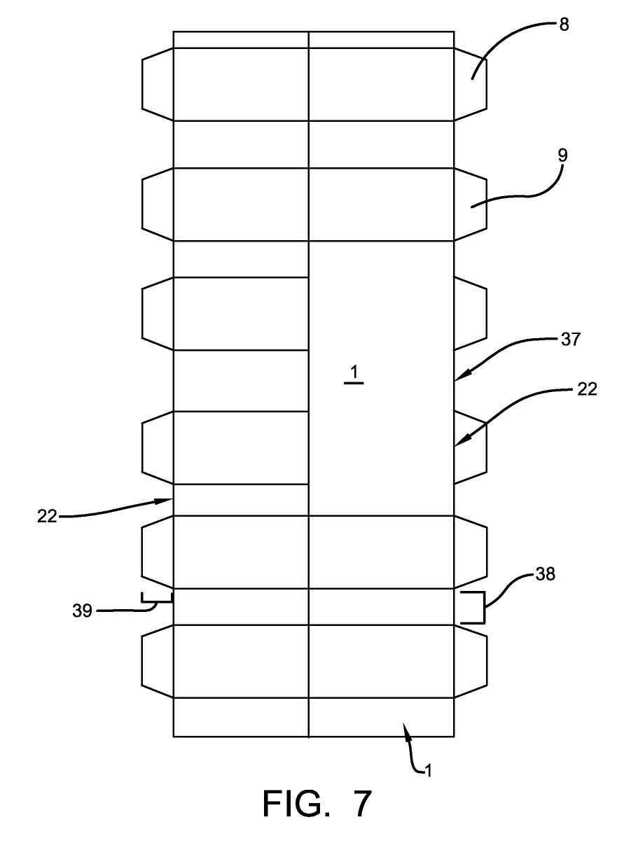

FIG. 7 is a plug element with radially external seal elements,

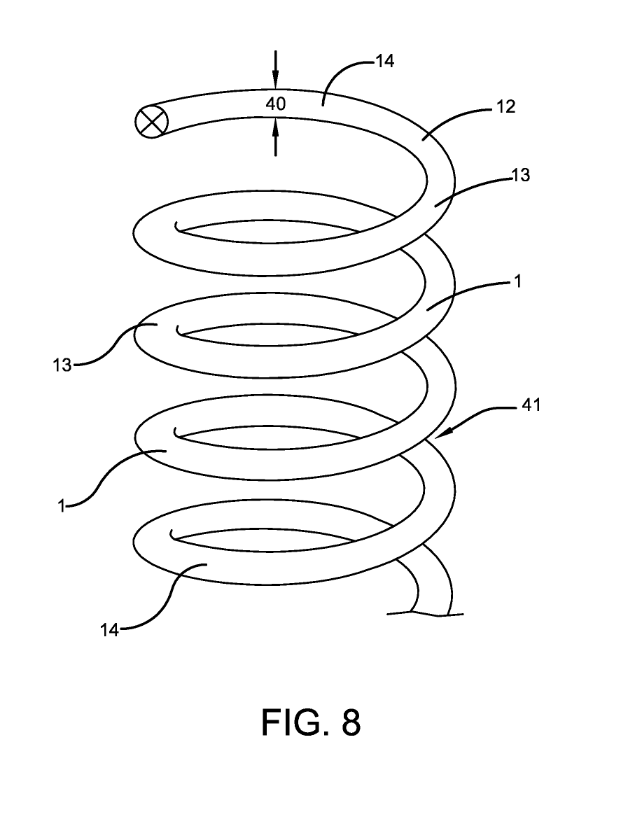

FIG. 8 the still missing turns from a wire made of the shape-memory-alloy for the preparation of a plug element,

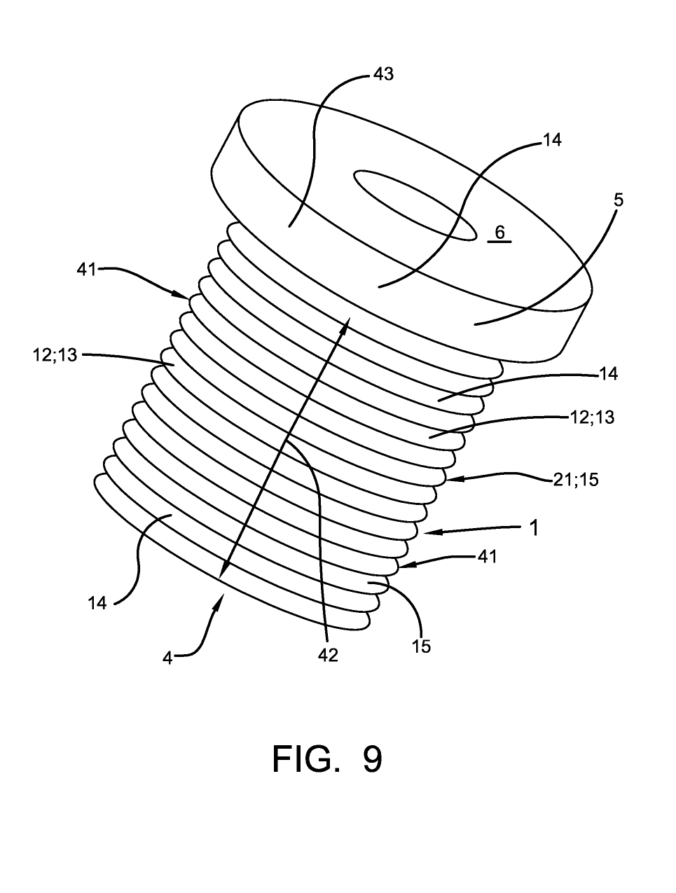

FIG. 9 a plug element corresponding to FIG. 8 with the difference that the turns of the wire are pressed on block,

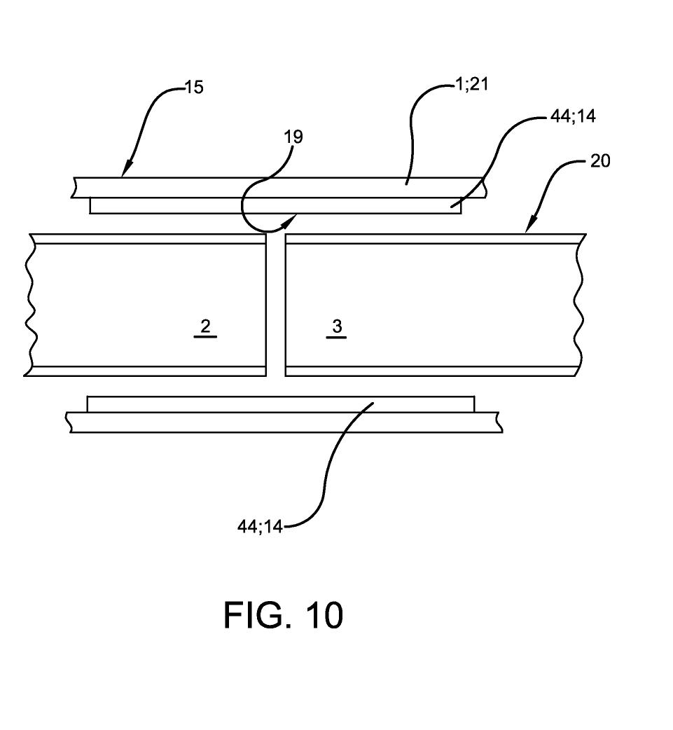

FIG. 10 a further development of the invention.

Subsequently only exemplarily and in no way exclusive it is assumed that a plug element 1 is coolable for mechanical widening or compression in the martensitic phase 15 and returns to its second shape 5 (FIG. 2) after heating.

In FIG. 1 the carrier elements 2 and 3 are inserted into plug element 1.

Since the plug element is on martensitic phase 15 and is widened compared to the second shape 5 (not shown), the plug element 1 shows a diameter 16 which is bigger than the diameter 17, 18 and the carrier elements 2 and 3.

When integrated, the carrier elements 2 and 3 may push each other preferably at the front sides.

FIG. 2 shows a plug element 1 according to FIG. 1 with both carrier elements 2 and 3 inserted into the plug element 1.

In FIG. 1 the plug element 1 is presented in its first shape 4 and is e.g. heated to a predefined temperature in FIG. 2.

With heating e.g. to room temperature the plug element 1 is transformed from its first shape 4 (FIG. 1) to the second shape 5 (FIG. 2).

In its second shape 5 the plug element 1 with inner diameter 19 is in contact to the respective outer diameter 20 of the carrier elements 2 and 3.

The plug element 1 comprises one body part 21 which is made from a shape-memory-alloy 14.

The plug elements 1 shown in FIGS. 1 to 7 comprise according to FIG. 8 turns of wire 12, 13 which are welded to the outer diameter 22 of the plug element 1 and transformed into a smooth surface 23.

The plug element 1 with its inner diameter 19 is in tight contact to the respective outer diameter 20 of the carrier elements 2, 3.

The carrier parts 2, 3 push each other preferably on the front side in the interior of the plug element 1.

FIG. 3 shows two carrier elements 2 and 3 which exemplarily show plugs 6 and 7 at the opposing ends.

Unlike the FIGS. 1 and 2 the both carrier elements 2 and 3 are connected to each other via an interior plug element 1.

The plug element 1 is shown in its first shape 4 which is shrunk over an interior plug element 1.

During the transformation of the plug element 1 from the first shape 4 to the second shape 5 the plug element 1 radially stretches outward according to the arrows 24.

The plugs 6 and 7 are also shown in their condition in the first shape 4. Here plug 7 is widened towards the second shape 5 (not shown) while the interior plug 6 in the shown first shape 4 is radially shrunk towards the second shape 5.

For the transformation of the plugs 6 and 7 from the first shape 4 to the second shape 5 a widening of plug 6 takes place according to arrow 25.

A shrinking of plug 7 from the first shape 4 to the second shape 5 (not shown) takes place according to the arrows 26.

The inner diameter 19 of plug 7 attaches to the outer diameter 20 of the carrier element 2 with the transformation to the second shape 5.

With the widening of the plug element 1 and plug 6 from the transformation to the second shape 5 (comp. FIG. 4) the plug element 1 and plug 6 stretch according to the arrows 24 and 25.

From the widening resp. shrinking of the plug element 1, the plug 6 resp. plug 7 results in a tight connection between carrier elements 2 and 3 and the plug element 1 resp. between the carrier elements 2 and 3 and the plugs 6 and 7.

For clarification of the progress of plug element 1 in the interior of carrier elements 2 and 3 the both carrier elements 2 and 3 are shown distanced from each other on the front side. In assembled condition both carrier elements 2 and 3 preferably push each other on the front side.

Additionally a sealing plug 11 may be included between both front ends of the carrier elements 2 and 3.

Further sealing plugs 11 may be arranged between the respective contact surfaces of the carrier element 2 and 3 and the plug element 11 on the inner diameter 19 of plug element 1 or on its outer diameter 20.

It is also conceivable to arrange sealing plugs 11 at the respective outer diameter 20 resp. at the inner diameter 27 of the carrier elements 2 resp. 3.

Further sealing plugs 11 may be arranged at the inner diameter 28 resp. outer diameter 29 of the plugs 6 resp. 7, depending on whether the plug 6 resp. 7 connects to the inner diameter 27 of the respective carrier element 2, 3 or to the outer diameter 20 of the carrier elements 2, 3.

FIG. 4 shows a depiction according to FIG. 3 with the difference that plug element 1 is transformed from the first shape 4 (FIG. 3) to the second shape 5 and is in tight contact with its outer diameter 22 to the inner diameter 27 of the respective carrier element 2, 3.

In the depiction of FIG. 4 the plug element 1 has radially stretched and possibly axially according to the arrows 24 (FIG. 3).

With the transformation from the first shape 4 (FIG. 3) to the second shape 5 (FIG. 4) the plug 6 expands according to arrow 5.

In the same way plug 7 shrinks from its first shape 4 (FIG. 3) to the second shape 5 in which plug 7 is shown in FIG. 4.

The expansion (plug 6 and plug element 1) and the shrinking of plug 7 from the first shape 4 to the second shape 5 causes a tight contact of the outer diameters 22 (plug element 1) and 29 (plug 6) towards the respective inner diameter 27 of the carrier elements 2 and 3.

The remarks of FIG. 3 regarding the sealing plugs 11 apply in the same way to FIG. 4.

FIG. 5 corresponds the depiction of FIG. 1 with the difference that structural elements 8 and 9 are arranged at the inner diameter of plug element 1 which individually determine the pressure distribution between plug element 1 and the carrier elements 2 and 3.

The structural elements may preferably be interlocked (structural element 8) or have a radiused structure (structural element 9).

The structural elements 8, 9 may preferably be made from metal and connected to plug element 1 in one piece.

For a better connection between plug element 1 and the respective carrier element 2, 3 structural element 8, 9 is preferably made from metal which is preferably softer than the material of plug element 1.

The structural elements 8, 9 show even and/or uneven indentations which are additionally filled with sealing plugs 11.

In FIG. 5 plug element 1 is shown in its first shape 4 which is widened towards the carrier elements 2 and 3.

With a following heating plug element 1 shrinks to the outer diameter 20 of the respective carrier element 2, 3.

During the shrinking the structural elements 8, 9 are squeezed and intensify the support and the sealing of plug element 1 towards the carrier elements 2 and 3.

FIG. 6 shows a repair kit 10 with three body parts 31, 32, 33 which stretch on a common level 30.

On each of the body parts 31 and 32 a carrier element 34 and a carrier element 35 is arranged. Both body parts 31 and 32 of the plug element 1 of the repair kit 10 are shown shrunk in its first shape (body part 31) and widened (body part 32).

During the transformation of the body parts 31 and 32 from the first shape 4 to the second shape 5 (not shown) body part 31 widens according to the arrows 24 and attaches in the second shape 5 to the inner diameter 27 of the carrier element 2.

Body part 32 is plugged to carrier element 35 in its first shape 4.

In the depiction of FIG. 6 body part 32 in its first shape 4 is widened towards the carrier element 35 according to the arrows 24.

With heating from the martensitic phase 15 body part 32 shrinks according to the arrows 26 and attaches in the second shape 5 (not shown) with its inner diameter 19 to the outer diameter 20 of carrier element 35.

Body part 33 of the plug element 1 of repair kit 10 is sealed with a plug 6.

In FIG. 6 plug 6 is shown in its second shape 5.

In its second shape 5 shown in FIG. 6 the plug 6 with its outer diameter 29 attaches to the inner diameter 19 of body part 33.

FIG. 7 shows plug element 1 with structural elements 8, 9 which radially stand out from the outer diameter 22 of plug element 1.

In order to take a load off an area 37 of the plug element in assembled condition in a carrier element 2, 3 (not shown) the structural elements 8, 9 in area 37 of plug element 1 are excluded.

The structural elements 8, 9 are axially arranged with a distance 38 from each other.

Radially to the longitudinal axis of plug element 1 the structural elements 8, 9 are levelled with a distance 39 to the outer diameter 22 of plug element 1.

FIG. 8 shows a wire 13 made from a shape-memory-alloy 14 with its threads 12.

FIG. 8 shows the threads 12 of plug element 1 before welding so that the threads 12 of wire 13 made from shape-memory-alloy 14 are still in a distance to each other.

The threads 12 of wire 13 show a diameter 40.

The threads shown in FIG. 8 have a helical or circular run and show the grooves 41 between the single coils 12 which are leveled in the subsequent processing after being welded together to structural element 1.

In FIG. 9 plug element 1 with its body part 21 is shown in which the turns 12 of wire 13 made from a shape-memory-alloy are welded together. The grooves 41 (FIG. 8) are leveled in the depiction of FIG. 9.

The turns of wire 12, 13 made from a shape-memory-alloy 14 are compressed on block 42 following the welding and after leveling of the grooves 41 to the plug element 1.

In depiction of FIG. 9 the plug element 1 with its body part 21 is presented in the martensitic phase 15 and is shrunk to a first shape 4.

The plug element 1 can now be plugged into a carrier element 2 (not shown) and may be widened to its original shape 5 (not shown) by heating.

On the front side of body part 21 of the plug element 1 an exterior edge 43 of a plug 6 is shown.

FIG. 10 basically shows a presentation as in FIG. 1 with the difference that the plug element 1 shows at least a body part 21 of a plug element 1 which is widened in the martensitic phase 15 and is inserted into the carrier elements 2 and 3.

On the inside of the body part 21 facing the carrier elements 2, 3 the plug element 1 shows an insert, preferably an inliner 44. The inliner may be made from a shape-memory-alloy 14 or from a preferably soft metal in order to follow the widening resp. the shrinking of the body part 21.

The plug element 1 and the inliner 44 are force-fit and/or firmly bonded to each other.

If the inliner 44 is heated along with the plug element 1 it shrinks back to its original shape (not shown) and follows the radially externally adjacent plug element during shrinking. The plug element shown in FIG. 10 and/or the inliner 44 may comprise a material made from shape-memory-alloy 14.

### REFERENCE NUMBERS

1. Plug Element
2. Carrier Element
3. Carrier Element
4. First Shape
5. Second Shape
6. Plug
7. Plug
8. Structural Element
9. Structural Element
10. Repair Kit
11. Sealing Plug
12. Threading
13. Wire
14. Shape-Memory-Alloy
15. Martensite Phase
16. Cross Section
17. Cross Section
18. Cross Section
19. Inner Circumference of the Plug Element
20. Outer Circumference of the Plug Element
21. Body Part
22. Outer Circumference Plug Element
23. Smooth Surface Plug Element
24. Arrow
25. Arrow
26. Arrow
27. Inner Circumference Carrier Element
28. Inner Circumference Plug
29. Outer Circumference Plug
30. Level
31. Body Part
32. Body Part
33. Body Part
34. Body Part
35. Carrier Element
36. Plug
37. Area
38. Axial Distance
39. Maximum radial Distance
40. Diameter Wire
41. Grooves
42. Block
43. Exterior Rim of Plug
44. Inliner/Insert

1-24. (canceled)

25. Plug element with at least one body part (21, 31, 32, 33) comprising a shape-memory-alloy material (14) and connectable with at least one carrier element (2, 3) in such a way that the body part (21, 31, 32, 33) is at least radially in contact to the carrier element in certain areas, characterized by the fact that the body part is coolable and can be mechanically deformed to a first shape that it can be transformed into a second shape with the subsequent heating, in which the body part (21, 31, 32, 33) is radially firmly and tightly in contact to the carrier element (2, 3).

26. Plug element according to claim 25, characterized by the fact that the body part (21, 31, 32, 33) features the shape of a shell which can be mechanically widened after cooling by an increase of its inner diameter in such a way that it may be attached to at least one cylindrical carrier element (2, 3) and that during subsequent heating it assumes the second shape in which its narrowed inner circumference is radially firmly and tightly in contact to the outer circumference of the at least one carrier element (2, 3) or which is mechanically shrinkable after cooling by a reduction of its inner diameter to the first shape in such a way that it is pluggable to at least one cylindrical carrier element (2, 3) and that during subsequent heating it assumes the second shape in which its increased outer circumference is radially firmly and tightly in contact to the inner circumference of the at least one carrier element (2, 3).

27. Plug element according to claim 25, characterized by the fact that the body part (21, 31, 32, 33) consists of at least one turn (12) of a wire (13) which can be mechanically widened after cooling to the first shape by an increase of its inner diameter in such a way that it may be attached to at least one cylindrical carrier element (2, 3) and that it assumes the second shape during subsequent heating in which its narrowed inner circumference is radially firmly and tightly in contact to the outer circumference of the at least one carrier element (2, 3) or which is mechanically shrinkable after cooling by a reduction of its inner diameter to the first shape in such a way that it is pluggable to at least one cylindrical carrier element (2, 3) and that during subsequent heating it assumes the second shape in which its increased outer circumference is radially firmly and tightly in contact to the inner circumference of at least one carrier element (2, 3).

28. Plug element according to claim 25, characterized by the fact that the body part (21, 31, 32, 33) is prepared by cold forming before cooling.

29. Plug element according to claim 27, characterized by the fact that the body part (21, 31, 32, 33) features two or more turns of wire which are welded together.

30. Plug element according to claim 27, characterized by the fact that the body part (21, 31, 32, 33) features two or more turns of wire (12, 13) which are coiled to the shape of a spring or pressed on block (42).

31. Plug element according to claim 25, characterized by the fact that the body part (21, 31, 32, 33) is mechanically widened or shrunk to the first shape (4) during a martensitic phase (15).

32. Plug element according to claim 31, characterized by the fact that the body part (21, 31, 32, 33) is shrunk and/or widened from the first shape (4) to another shape (5) by heating during the martensitic phase.

33. Plug element according to claim 25, characterized by the fact that between the body part (21, 31, 32, 33) and the at least one carrier element (2, 3) and at least one axial and/or radial seal body (11) is arranged.

34. Plug element according to claim 25, characterized by the fact that the first shape (4) and/or another shape (5) is/are a defined shape.

35. Plug element according to claim 25, characterized by the fact that shape-memory-alloy (14) comprises nickel and titanium and niobium and/or zirconium.

36. Plug element according to claim 25, characterized by the fact that the at least one area of the body part (21, 31, 32, 33) adjoining (37) the carrier element (2, 3) is structured, preferably featuring the shape of cogging or the shape of knobs.

37. Plug element according to claim 36, characterized by the fact that the areas of the body parts (21, 31, 32, 33) adjoining (37) a carrier element (2, 3) feature inner diameters (16) or outer diameters (22) deviating from each other.

38. Plug element according to claim 25, characterized by the fact that the plug element (1) is an open, preferably hollow profile with the shape of a pitch cylinder.

39. Plug element according to claim 25, characterized by the fact that the plug element (1) is a closed hollow profile to at least one front side.

40. Plug element according to claim 25, characterized by the fact that the body part (21, 31, 32, 33) of the plug element (1) features an areal wall.

41. Plug element according to claim 25, characterized by the fact that the body part (21, 31, 32, 33) of the plug element (1) features a grid structure.

42. Plug element according to claim 25, characterized by the fact that the plug element (1, 34, 35) comprises at least two body parts (21, 31, 32, 33) whose inner diameters (16) deviate from each other.

43. Plug element with at least one body part (21, 31, 32, 33) comprising a shape-memory-alloy (14) and is connectable with a least one carrier element (2, 3) in such a way that the body part (21, 31, 32, 33) with its circumference is at least radially in contact with the carrier element in certain areas, characterized by the fact that the body part (21, 31, 32, 33) is fillable with a fluid and is coolable and can be deformed to the first shape by the fluid that the body part (21, 31, 32, 33) is transformable to a second shape during the subsequent heating in which the body part (21, 31, 32, 33) is radially and tightly in contact to the carrier element (2, 3).

44. Plug element according to claim 43, characterized by the fact that the fluid is a refrigerant or cryogen.

45. Plug element according to claim 43, characterized by the fact that the fluid is liquid, gelatinous or gaseous.

46. Plug element according to claim 43, characterized by the fact that the fluid may be applied with a pressure.

47. Plug element according to claim 43, characterized by the fact that the body part (21, 31, 32, 33) has a front side and is sealable for the purpose of filling.

48. Procedure for the preparation of a plug element with at least one body part (21, 31, 32, 33) comprising
a shape-memory-alloy material (14) and connectable with at least one carrier element (2, 3) in such a way that the body part (21, 31, 32, 33) is at least radially in contact to the carrier element in certain areas, characterized by the fact that the body part is cooled and can be mechanically deformed to a first shape that it can be transformed into a second shape with the subsequent heating, in which the body part (21, 31, 32, 33) is radially firmly and tightly in contact to the carrier element (2, 3).
